(19) United States
(12) Patent Application Publication
(10) Pub. No.: US 2013/0307860 A1
(43) Pub. Date: Nov. 21, 2013

(54) Preempting Fixed Function Media Devices

(71) Applicants: Mostafa Hagog, Kaukab (IL); Eran Shifer, Tel Aviv (IL); Scott W. Cheng, Folsom, CA (US); Brian D. Rauchfuss, Shingle Springs, CA (US); Eli Turiel, Shimshit Z (IL)

(72) Inventors: Mostafa Hagog, Kaukab (IL); Eran Shifer, Tel Aviv (IL); Scott W. Cheng, Folsom, CA (US); Brian D. Rauchfuss, Shingle Springs, CA (US); Eli Turiel, Shimshit Z (IL)

(21) Appl. No.: 13/992,362

(22) PCT Filed: Mar. 30, 2012
(86) PCT No.: PCT/US12/31344

§ 371 Date: Jun. 7, 2013

(51) Int. Cl. G06T 1/20

(52) U.S. Cl. CPC G06T 1/20
USPC 345/522

(57) ABSTRACT

In accordance with some embodiments, a fixed function media accelerator may be preempted in the middle of processing one frame of data and still be able to resume operation later without the need to save an internal state. This ability to be preempted, without saving an internal state, may be important for supporting page fault and increasing the responsiveness of fixed function engines. Enabling preemption without the need to save the entire state reduces the complexity of the implementation in some embodiments.

### BACKGROUND

This relates generally to processing media, including graphics, video, and audio.

A fixed function media accelerator performs one fixed function associated with media processing, such as decoding, video and image enhancement, or video and image analysis.

In conventional fixed function media devices, preemption only occurs on frame boundaries. With this approach, the entire internal state of the fixed function accelerator is saved and restored.

### BRIEF DESCRIPTION OF THE DRAWINGS

Some embodiments are described with respect to the following figures:

FIG. 1 is a schematic depiction of one embodiment of the present invention;

FIG. 2 is a flow chart for one embodiment of the present invention;

FIG. 3 is a system schematic in accordance with one embodiment of the present invention; and

FIG. 4 is a front elevational view of a system according to one embodiment of the present invention.

### DETAILED DESCRIPTION

In accordance with some embodiments, a fixed function media accelerator may be preempted in the middle of processing one frame of data and still be able to resume operation later without the need to save an internal state. This ability to be preempted, without saving an internal state, may be important for supporting page fault and increasing the responsiveness of fixed function engines. Enabling preemption without the need to save the entire state reduces the complexity of the implementation in some embodiments.

A fixed function device may implement preemption by defining the atomic commit points in a command architecture. As a result, preemption of the operation of the fixed function on well-defined commit points may be possible, while indicating the progress of the operation that is being performed. Defining these commit points also defines the architecture and the behavior expected from software interacting with the fixed function accelerator, in some embodiments.

Fixed function accelerator commands may be related to either input or output memory. As a result, the fixed function accelerator may be viewed as a direct memory access (DMA) engine from a source memory to a destination memory. In addition, a direct memory access operation accelerator may perform computation on source operands and write the results of computations, rather than performing a straight copy.

Accelerator commands need not be atomic. However, there may be cases where writing results is done on well-defined atomic boundaries. For each accelerator function, the smallest atomic element that can be written by the accelerator as a whole may be defined as an atomic element. Once execution of one atomic element is considered complete, then only its values are available to the calling program.

A progress bar field in an accelerator command may indicate the amount of atomic elements that have been processed so far. To handle the case where the inputs and outputs are not of the same size and the relationship is not known a priori, a progress bar may be defined as two fields. The first field is progress on the input and the second field is progress on the output.

The progress bar may be updated on each commit of work to reflect the remaining work. The progress bar field changes may be visible to the program during execution.

When the accelerator's work has been suspended or preempted, saving and restoring the command with the updated progress bar is all that is needed to resume the accelerator operation from the last commit point. Once the accelerator completes execution of a command, the progress bar may be set to a special value for command completion for the software. There are two special values for the progress bar, one to indicate a fresh start of a command and another to indicate command completion. Any value that is different, means that command execution is a restart from a previously preempted command.

In some embodiments, shared virtual memory may be supported between the central processing unit and media accelerators. This may allow a system to make forward progress on the fixed function with a small number of open pages that a paging system can cope with. Thus, some embodiments may reduce the number of pages required to assure forward progress from thousands to several tens of pages.

By defining an addition to the fixed function accelerator commands that allows defining the smallest atomic element that can be completed entirely, some embodiments allow a fixed function accelerator command to be resumed or retired without special handling from the software. In addition, a progress bar field in the command architecture defines the expected behavior of an accelerator function and the expected results with different conditions.

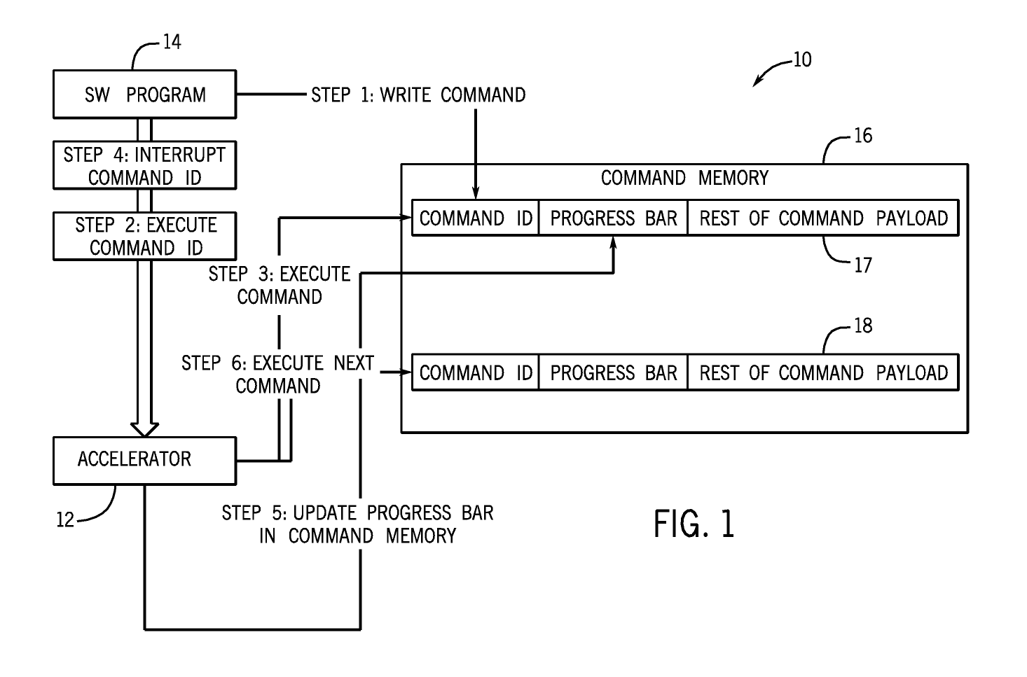

Thus, referring to FIG. 1, the software program 14 interacts with the fixed function accelerator 12. The accelerator may process media, including one or more of graphics, video, or audio. Examples of media accelerators include devices for decoding, video and image enhancement, and video and image analysis. The accelerator 12 uses a command memory 16. The command memory may store, in this example, two commands 17 and 18. Each command includes an identifier, a progress bar, and the rest of the command payload.

The first step is for the software program 14 to write the command to command memory 16. Then the software program executes the command identifier obtained from the command identifier command 17 or 18. Next, the command itself is executed. Thereafter, the operation of the command identifier may be interrupted. This interruption results in an update of the progress bar in the command memory, as indicated by step 5. Then the next command may be executed, in this case the command 18, as indicated in step 6.

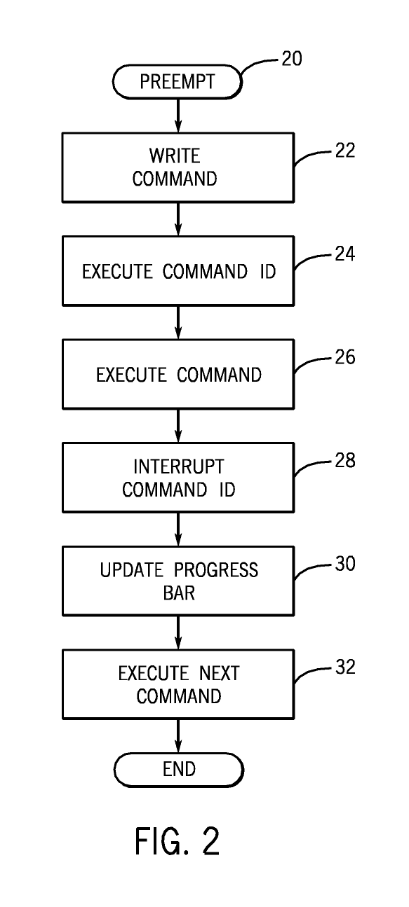

Referring to FIG. 2, a sequence 20 may be implemented in software, firmware, and/or hardware. In software and firmware embodiments, it may be executed by computer executed instructions stored in a non-transitory computer readable medium, such as an optical, magnetic, or semiconductor storage.

The sequence 20 may enable preemption on atomic elements. Initially, the software program writes the command to the command memory, as indicated in block 22. The command may include a command identifier, the progress bar field, and the rest of the command payload.

Then the command identifier is executed, as indicated in block 24, followed by execution of the command, as indicated in block 26. To interrupt the command identifier, as indicated in block 28, the progress bar may be updated, as indicated in block 30. Then the next command may be executed, as indicated in block 32.

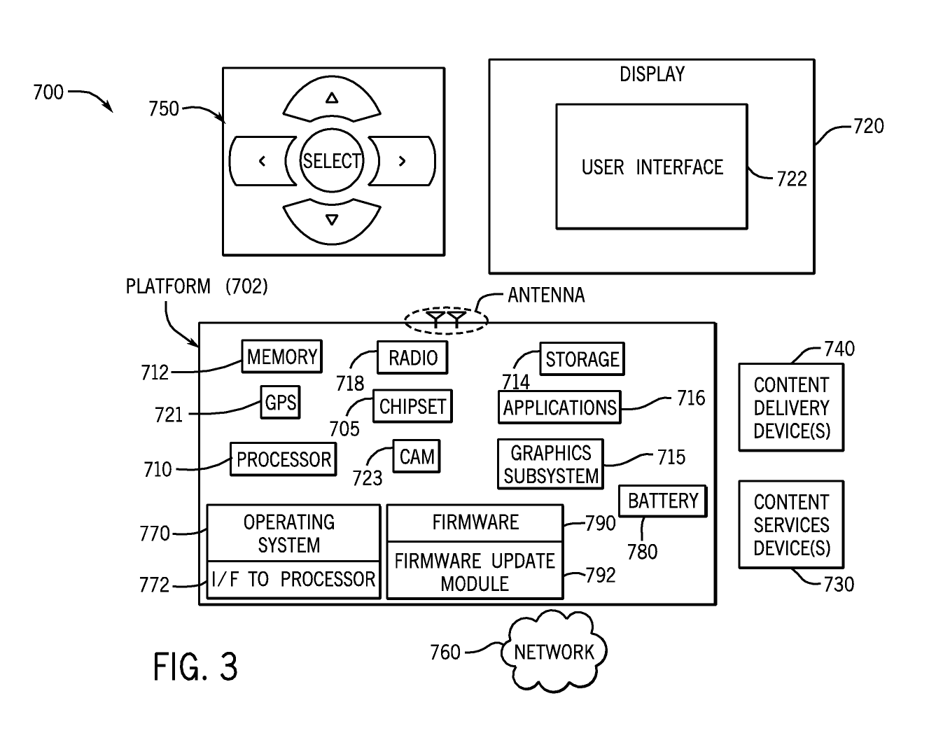

FIG. 3 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716, global positioning system (GPS) 721, camera 723 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

In addition, the platform 702 may include an operating system 770. An interface to the processor 772 may interface the operating system and the processor 710.

Firmware 790 may be provided to implement functions such as the boot sequence. An update module to enable the firmware to be updated from outside the platform 702 may be provided. For example the update module may include code to determine whether the attempt to update is authentic and to identify the latest update of the firmware 790 to facilitate the determination of when updates are needed.

In some embodiments, the platform 702 may be powered by an external power supply. In some cases, the platform 702 may also include an internal battery 780 which acts as a power source in embodiments that do not adapt to external power supply or in embodiments that allow either battery sourced power or external sourced power.

The sequence shown in FIG. 2 may be implemented in software and firmware embodiments by incorporating them within the storage 714 or within memory within the processor 710 or the graphics subsystem 715 to mention a few examples. The graphics subsystem 715 may include the graphics processing unit and the processor 710 may be a central processing unit in one embodiment.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 3.

As described above, system 700 may be embodied in varying physical styles or form factors. FIG. 5 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

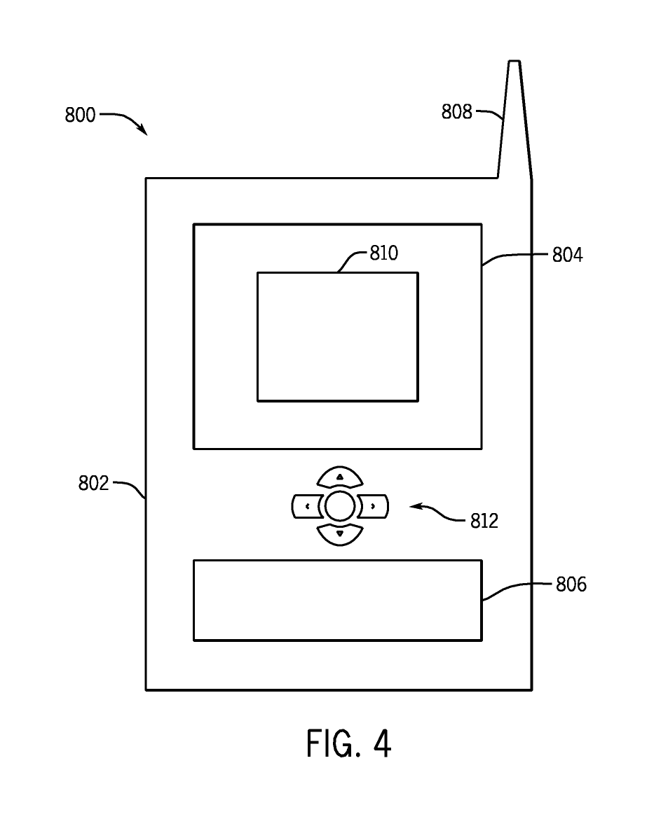

As shown in FIG. 4, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

The following clauses and/or examples pertain to further embodiments:

1. A method comprising:
using atomic commit points in a command architecture of a fixed function media accelerator to enable preemption of the fixed function accelerator's operation without the need to save an internal state.
   2. The method of clause 1 including indicating the progress of the operation.
   3. The method of clause 2 including providing a progress bar within a command field.
   4. The method of clause 1 including defining accelerator commands relative to input and output memory.
   5. The method of clause 1 including defining said atomic elements as the smallest atomic element that can be written as a whole by the accelerator.
   6. The method of clause 2 including providing a progress bar with two fields, the first field indicating the progress on the input and the second field indicating the progress on the output.
   7. The method of clause 6 including updating the progress bar on each commit of work to reflect the remaining work.
   8. The method of clause 3 including saving and restoring a command with the progress bar when the accelerator is preempted.
   9. The method of clause 1 including using at least two values for command completion, including one to indicate a fresh start of the command and another to indicate command completion.
   10. The method of clause 1 including writing a command to a command memory, executing a command identifier and then executing the command.
   11. The method of clause 9 including interrupting a command identifier and then updating the progress bar in the command memory.
   12. At least one machine readable medium comprising a plurality of instructions that in response to being executed on a computing device, cause the computing device to carry out the method according to any one of claims 1 through 11.
   13. An apparatus for fixed function acceleration configured to perform the method of any one of clauses 1 through 11.
   14. An apparatus comprising:
a graphics accelerator adapted to be preempted without the need to save an internal state; and
a command memory coupled to said graphics accelerator, said command memory including command identifiers and a progress bar to indicate the progress of a series of operations.
   15. The apparatus of clause 14 wherein said graphics accelerator is a fixed function graphics accelerator.
   16. The apparatus of clause 14, said accelerator to indicate the progress of the operation using said progress bar.
   17. The apparatus of clause 16, said accelerator to use commands relative to input and output memory.
   18. The apparatus of clause 14, said accelerator to operate on atomic elements defined as the smallest atomic element that can be written as a whole by the accelerator.
   19. The apparatus of clause 14, said accelerator to provide a progress bar with two fields, the first field indicating the progress on the input and the second field indicating the progress on the output.
   20. The apparatus of clause 19, said accelerator to update the progress bar on each commit of work to reflect the remaining work.
   21. The apparatus of clause 14, said accelerator to save and restore a command with the progress bar when the accelerator is preempted.
   22. The apparatus of clause 14, said accelerator to use at least two values for command completion, including one to indicate a fresh start of the command and another to indicate command completion.
   23. The apparatus of clause 14, said accelerator to write a command to the command memory, execute the command identifier, and then execute the command.
   24. The apparatus of clause 23, said accelerator to interrupt a command identifier and then update the progress bar in command memory.
   25. The apparatus of clause 14, including an operating system.
   26. The apparatus of clause 14, including a battery.
   27. The apparatus of clause 14, including firmware and a module to update said firmware.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
using atomic commit points in a command architecture of a fixed function media accelerator to enable preemption of the fixed function accelerator's operation without the need to save an internal state.

2. The method of claim 1 including indicating the progress of the operation.

3. The method of claim 2 including providing a progress bar within a command field.

4. The method of claim 1 including defining accelerator commands relative to input and output memory.

5. The method of claim 1 including defining said atomic elements as the smallest atomic element that can be written as a whole by the accelerator.

6. The method of claim 2 including providing a progress bar with two fields, the first field indicating the progress on the input and the second field indicating the progress on the output.

7. The method of claim 6 including updating the progress bar on each commit of work to reflect the remaining work.

8. The method of claim 3 including saving and restoring a command with the progress bar when the accelerator is preempted.

9. The method of claim 1 including using at least two values for command completion, including one to indicate a fresh start of the command and another to indicate command completion.

10. The method of claim 1 including writing a command to a command memory, executing a command identifier and then executing the command.

11. The method of claim 9 including interrupting a command identifier and then updating the progress bar in the command memory.

12. At least one machine readable medium comprising a plurality of instructions that in response to being executed on a computing device, cause the computing device to carry out the method comprising:
using atomic commit points in a command architecture of a fixed function media accelerator to enable preemption of the fixed function accelerator's operation without the need to save an internal state.

13. (canceled)

14. An apparatus comprising:
a graphics accelerator adapted to be preempted without the need to save an internal state; and
a command memory coupled to said graphics accelerator, said command memory including command identifiers and a progress bar to indicate the progress of a series of operations.

15. The apparatus of claim 14 wherein said graphics accelerator is a fixed function graphics accelerator.

16. The apparatus of claim 14, said accelerator to indicate the progress of the operation using said progress bar.

17. The apparatus of claim 16, said accelerator to use commands relative to input and output memory.

18. The apparatus of claim 14, said accelerator to operate on atomic elements defined as the smallest atomic element that can be written as a whole by the accelerator.

19. The apparatus of claim 14, said accelerator to provide a progress bar with two fields, the first field indicating the progress on the input and the second field indicating the progress on the output.

20. The apparatus of claim 19, said accelerator to update the progress bar on each commit of work to reflect the remaining work.

21. The apparatus of claim 14, said accelerator to save and restore a command with the progress bar when the accelerator is preempted.

22. The apparatus of claim 14, said accelerator to use at least two values for command completion, including one to indicate a fresh start of the command and another to indicate command completion.

23. The apparatus of claim 14, said accelerator to write a command to the command memory, execute the command identifier, and then execute the command.

24. The apparatus of claim 23, said accelerator to interrupt a command identifier and then update the progress bar in command memory.

25. The apparatus of claim 14, including an operating system.

26. The apparatus of claim 14, including a battery.

27. The apparatus of claim 14, including firmware and a module to update said firmware.

28. The medium of claim 12 further storing instructions to carry out a method including indicating the progress of the operation.

29. The medium of claim 12 further storing instructions to carry out a method including providing a progress bar within a command field.

30. The medium of claim 12 further storing instructions to carry out a method including defining accelerator commands relative to input and output memory.

31. The medium of claim 12 further storing instructions to carry out a method including defining said atomic elements as the smallest atomic element that can be written as a whole by the accelerator.
